(19) United States
(12) Patent Application Publication
(10) Pub. No.: US 2025/0330750 A1
(43) Pub. Date: Oct. 23, 2025

(54) ELECTRONIC DEVICE FOR MATCHING PROJECTION SCREEN WITH SOUND IMAGE, AND METHOD FOR CONTROLLING SAME

(71) Applicant: SAMSUNG ELECTRONICS CO., LTD., Suwon-si, Gyeonggi-do (KR)

(72) Inventors: Jongbae KIM, Suwon-si (KR); Dongkyu PARK, Suwon-si (KR); Donghyun JUNG, Suwon-si (KR); Seungwan CHO, Suwon-si (KR)

(73) Assignee: SAMSUNG ELECTRONICS CO., LTD., Suwon-si, Gyeonggi-do (KR)

(21) Appl. No.: 19/069,868

(22) Filed: Mar. 4, 2025

Related U.S. Application Data
(63) Continuation of application No. PCT/KR2023/015165, filed on Oct. 4, 2023.

(30) Foreign Application Priority Data
Nov. 21, 2022 (KR) 10-2022-0156758

(51) Int. Cl. H04R 3/14; G06F 3/16; H04R 1/02; H04R 5/02; H04S 1/00

(52) U.S. Cl. CPC H04R 3/14; G06F 3/165; H04R 1/023; H04R 1/028; H04R 5/02; H04S 1/007; H04R 2499/15

(57) ABSTRACT

An electronic device comprising a projection unit; a first speaker to output sound toward a front of the electronic device which is the projection direction of the projection unit, the first speaker including a speaker cover having a plurality of holes; a second speaker to output sound to at least one of a rear or a side of the electronic device; and at least one processor connected to the projection unit, the first speaker, and the second speaker to control the electronic device, wherein the processor may control the first speaker to output a first sound in a first frequency band, and control the second speaker to output a second sound in a second frequency band lower than the first frequency band.

### CROSS-REFERENCE TO RELATED APPLICATION

This application is a continuation application is a continuation application, under 35 U.S.C. § 111(a), of international application No. PCT/KR2023/015165, filed Oct. 4, 2023, which claims priority under 35 U. S. C. § 119 to Korean Patent Application No. 10-2022-0156758, filed Nov. 21, 2022, the disclosures of which are incorporated herein by reference in their entireties.

### TECHNICAL FIELD

The disclosure relates to an electronic device and a control method thereof, and more particularly to an electronic device that matches a projection screen with a sound image and a control method thereof.

### BACKGROUND ART

Electronic devices that provide various functions are being developed with the development of electronic technology. Specifically, projectors of various forms with which large screens can be easily enjoyed are being released with increased outdoor activity and diversification of personal devices within the home.

For example, an ultra-short throw projector may be installable directly in front of a projection surface (screen) without having to install at a ceiling with the development of optical systems. Most ultra-short throw projectors may be equipped with stereo speakers and provide sound together therewith from a main body of the projector.

Because the ultra-short throw projector is installed on the same line as a left, right, and center of the projection surface, a left and right sound output from the projector may be configured such that a left and right balance is maintained based on the center of the screen.

Alternatively, a pico (mini) projector is small scale for movement and installation to be easy breaking away from the projectors of the related art which has to be mounted at the ceiling, and is equipped with an auto keystone function which reduces screen distortion according to a mounting position and an auto focusing function.

Even if a consumer installs the projector at a position spaced apart from a center line of the projection surface through the auto keystone function, the screen may be adjusted to a rectangular parallelepiped shape. Accordingly, a user may easily use the projector even in various conditions such as installing the projector at a position deviated from the center of the screen, projecting at a tilted screen, or directly projecting at the ceiling.

Because small to medium scale projectors as described above provide sound together with the screen through a mono speaker or stereo speaker implemented within the main body unlike medium to large scale projectors which are mostly installed at the ceiling, no connection with a separate external sound system is necessary.

However, because the small to medium scale projectors as described above are provided with the auto keystone function, the above may be installed at a position deviated to one side from the center line of the projection surface, and in this case, the speaker inside the small to mid scale projector may also radiate sound from a position deviated toward one side from the center line of the projection surface, and a phenomenon of sound bias may occur. That is, a mismatch of the screen and sound may be intensified.

For example, if the projector projects at the ceiling as shown in FIG. 1A, because sound is output from the main body and focused at the ears of the user, the phenomenon of sound bias may occur. That is, the screen may be positioned at the ceiling, but the sound may be focused at one ear mismatching the screen and the sound image, and a left and right imbalance may occur.

Alternatively, if the projector is installed at a side surface of the user as shown in FIG. 1B, the screen may maintain a rectangular shape without distortion through the auto keystone function, but the left and right imbalance in sound may occur.

Accordingly, there is a need for a method for relieving the left and right imbalance in sound to be developed.

### DISCLOSURE

### Technical Solution

According to an embodiment of the disclosure for achieving the object as described above, an electronic device includes a projection part, a first speaker to output sound toward a front surface of the electronic device that is a projection direction of the projection part, and the first speaker includes a speaker cover formed with a plurality of holes, a second speaker to output sound toward at least one of a back surface or a side surface of the electronic device, and at least one processor configured to control the electronic device by being connected with the projection part, the first speaker, and the second speaker, and the at least one processor is configured to control the first speaker to output a first sound of a first frequency band, and control the second speaker to output a second sound of a second frequency band which is lower than the first frequency band.

In addition, the plurality of holes of the speaker cover may be parallel in the projection direction, and the plurality of holes may have different diameters or areas based on a distance from an output point of the first sound.

Further, the speaker cover may include a remaining portion excluding the plurality of holes that is sealed, and the first sound may be output from the first speaker such that the first sound is constructively interfered by being delayed sequentially and output through the plurality of holes, and may have directivity in a direction that is being constructively interfered.

In addition, a sensor may be further included, and the at least one processor may be configured to identify a distance from the electronic device to a projection surface through the sensor, and correct at least one delay from among the first sound or the second sound based on the identified distance.

Further, a third speaker to output sound toward a front surface of the electronic device, the third speaker may include a speaker cover formed with a plurality of holes may be further included, and the at least one processor may be configured to control the first speaker to output sound of a first channel from the first sound, and control the third speaker to output sound of a second channel from the first sound.

In addition, a sensor may be further included, and the at least one processor may be configured to identify a projection angle formed by the projection direction and a projection surface through the sensor, and correct at least one delay from among the sound of the first channel or the sound of the second channel based on the projection angle.

Further, a user interface may be further included and the at least one processor may be configured to control, based on a user command for implementing an integrated screen through the electronic device and at least one other electronic device being received through the user interface, the projection part to project a portion of an area of an image, and control the first speaker to output sound of a channel corresponding to the portion of the area from among the first sound.

In addition, a communication interface may be further included, and the at least one processor may be configured to control the communication interface to transmit a remaining area of the image, a remaining channel of the first sound, and the second sound to the at least one other electronic device.

Further, a user interface may be further included, and the least one processor may be configured to control, based on a user command for implementing an integrated screen through the electronic device and at least one other electronic device being received through the user interface, the projection part to project one from among a plurality of content, control the first speaker to output the first sound of the first frequency band from a sound corresponding to one from among the plurality of content, and control the second speaker to output the second sound of the second frequency band from the sound.

In addition, a communication interface may be further included, and the least one processor may be configured to control the communication interface to transmit a remaining content of the plurality of content to the at least one other electronic device.

Further, the projection part may require a focal distance of greater than or equal to a pre-set distance.

Meanwhile, according to an embodiment of the disclosure, a control method of an electronic device includes outputting a first sound of a first frequency band through a first speaker toward a front surface of the electronic device that is a projection direction of a projection part included in the electronic device, the first speaker including a speaker cover formed with a plurality of holes, and outputting a second sound of a second frequency band, which is lower than the first frequency band through a second speaker, toward at least one from among a back surface or a side surface of the electronic device.

In addition, the plurality of holes of the speaker cover may be parallel to the projection direction, and the plurality of holes may have different diameters or areas based on a distance from an output point of the first sound.

Further, the speaker cover may have a remaining portion excluding the plurality of holes that is sealed, and the first sound may be output from the first speaker such that the first sound is constructively interfered by being delayed sequentially and output through the plurality of holes, and may have directivity in a direction that is being constructively interfered.

In addition, identifying a distance from the electronic device to a projection surface and correcting at least one delay from among the first sound or the second sound based on the identified distance may be further included.

Further, the outputting the first sound may include outputting sound of a first channel from the first sound through the first speaker, being disposed to output sound toward a front surface of the electronic device, and outputting sound of a second channel from the first sound through a third speaker which includes a speaker cover formed with a plurality of holes.

In addition, identifying a projection angle formed by the projection direction and a projection surface and correcting at least one delay from among sound of the first channel or sound of the second channel based on the projection angle may be further included.

Further, receiving a user command for implementing an integrated screen through the electronic device and at least one other electronic device and controlling the projection part to project a portion of an area of an image may be further included, and the outputting the first sound may include outputting sound of a channel corresponding to the portion of the area from among the first sound.

In addition, transmitting a remaining area of the image, a remaining channel of the first sound, and the second sound to the at least one other electronic device may be further included.

Further, receiving a user command for implementing an integrated screen through the electronic device and at least one other electronic device and controlling the projection part to project one from among a plurality of content may be further included, and the outputting the first sound may include outputting the first sound of the first frequency band from a sound corresponding to one from among the plurality of content, and the outputting the second sound may include outputting the second sound of the second frequency band from the sound.

In addition, transmitting a remaining content of the plurality of content to the at least one other electronic device may be further included.

Further, the projection part may require a focal distance of greater than or equal to a pre-set distance.

### DESCRIPTION OF DRAWINGS

FIG. 1A and FIG. 1B are diagrams illustrating a left and right imbalance of sound to assist in the understanding of the disclosure;

FIG. 2 is a block diagram illustrating a configuration of an electronic device according to an embodiment of the disclosure;

FIG. 3 is a block diagram illustrating a detailed configuration of an electronic device according to an embodiment of the disclosure;

FIG. 4 is a diagram illustrating an operation of a first speaker according to an embodiment of the disclosure;

FIG. 5 is a diagram illustrating characteristics of directivity according to an embodiment of the disclosure;

FIG. 6 is a diagram illustrating a structure of a first speaker according to an embodiment of the disclosure;

FIG. 7 is a diagram illustrating an example of a multi-channel directional speaker being included according to an embodiment of the disclosure;

FIG. 8 is a diagram illustrating a time align matching of a first speaker and a second speaker according to an embodiment of the disclosure;

FIG. 9 and FIG. 10 are diagrams illustrating a time align matching when a multi-channel directional speaker is included according to an embodiment of the disclosure;

FIG. 11 is a diagram illustrating an operation of an electronic device 100 when projecting one image using the electronic device 100 and at least one other electronic device according to an embodiment of the disclosure;

FIG. 12 is a diagram illustrating an operation of an electronic device 100 when projecting a plurality of content using the electronic device 100 and at least one other electronic device according to an embodiment of the disclosure; and

FIG. 13 is a flowchart illustrating a control method of an electronic device according to an embodiment of the disclosure.

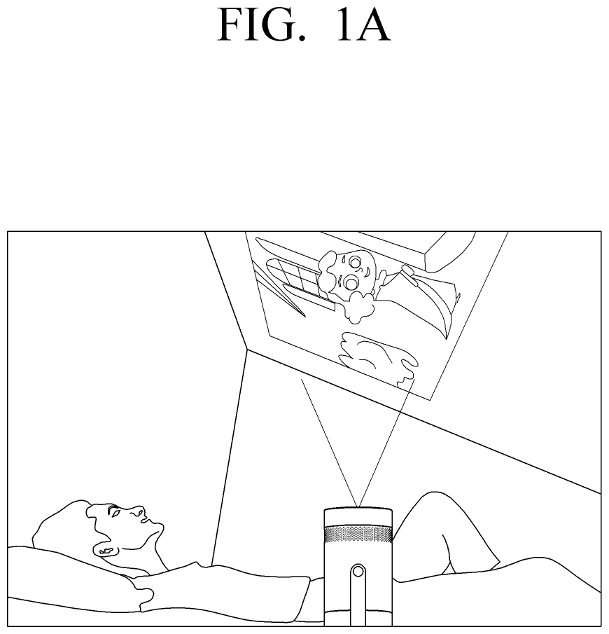

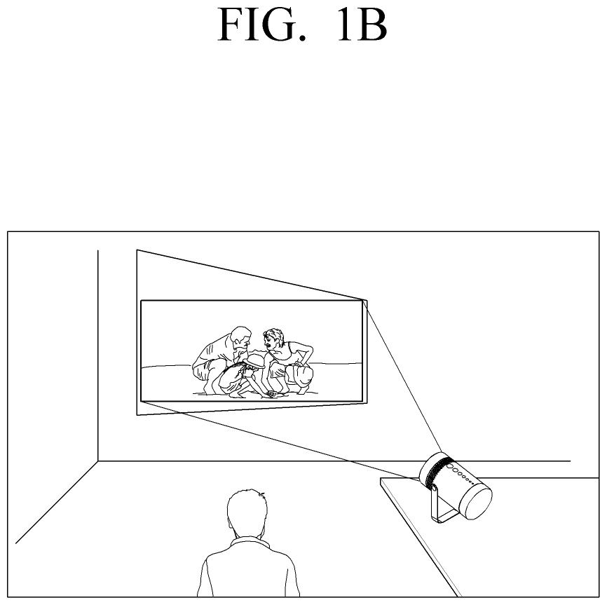

### MODE FOR INVENTION

An object of the disclosure is in providing an electronic device that matches a projection screen and a sound image and a control method thereof.

The disclosure will be described in detail below with reference to the accompanying drawings.

Terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the relevant description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one from among “A” or “B” or “A and B”.

Expressions such as “1st”, “2nd”, “first” or “second” used in the disclosure may limit various elements regardless of order and/or importance, and may be used merely to distinguish one element from another element and not limit the relevant element.

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

In the disclosure, the term “user” may refer to a person using an electronic device or a device (e.g., artificial intelligence electronic device) using the electronic device.

Various embodiments of the disclosure will be described in greater detail below with reference to the accompanied drawings.

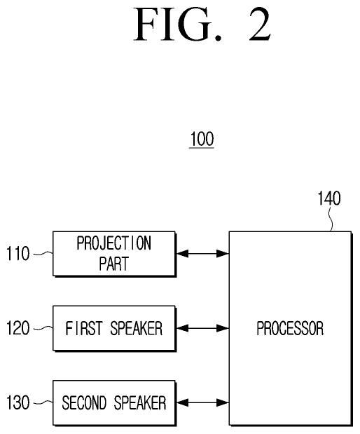

FIG. 2 is a block diagram illustrating a configuration of an electronic device 100 according to an embodiment of the disclosure.

The electronic device 100 may be a device that outputs directional sound in a projection direction of a screen. For example, the electronic device 100 may be a projector. Here, the electronic device 100 may be a projector which requires a focal distance of greater than or equal to a pre-set distance.

However, the embodiment is not limited thereto, and the electronic device 100 may be implemented as a speaker, and may output directional sound in the projection direction of the projector by being installed in the periphery of the projector.

Referring to FIG. 2, the electronic device 100 may include a projection part 110, a first speaker 120, a second speaker 130, and a processor 140.

The projection part 110 may project an image at a projection surface. Specifically, the projection part 110 may project an image or a picture including at least one from among content received from a source device or content that is pre-stored at a projection area using a light source such as a lamp or an LED.

The projection art 110 may be a configuration which requires a focal distance of greater than or equal to a pre-set distance. For example, the electronic device 100 may be implemented as a mini projector, and the projection part 110 may be a configuration that requires a focal distance of greater than or equal to a minimum of 1 m.

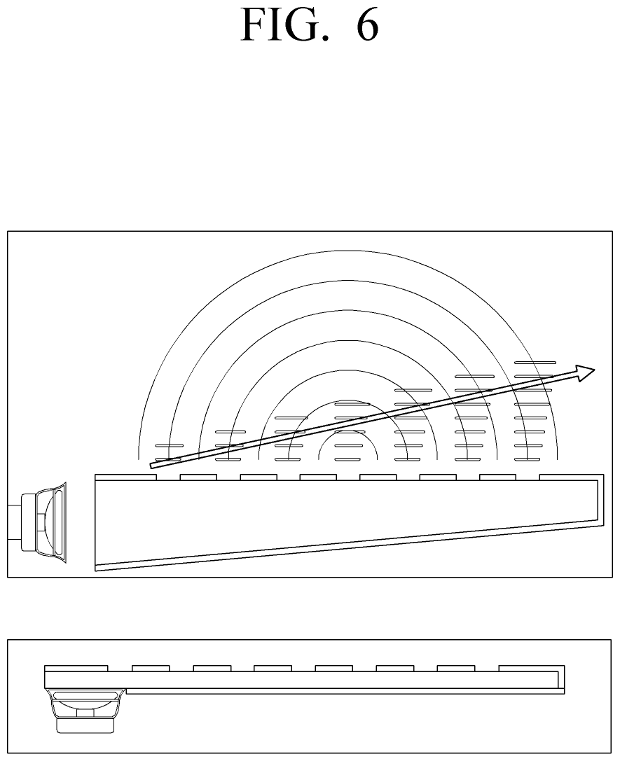

The first speaker 120 may receive an electric signal, and radiate sound by vibrating a diaphragm based on the input electric signal. The first speaker 120 may be include sound radiation holes. The sound radiation holes may be in a flat mesh form. Alternatively, the sound radiation holes may be in a curved mesh form. However, the embodiment is not limited thereto, and the sound radiation holes may not have a specific form. For example, one side of the first speaker 120 may be in a perforated form, and a sound damping material in mesh form may be disposed at a plurality of perforated holes in a horizontal direction or a lower part of the areas. In a speaker unit in FIG. 6 which will be described below, the sound radiation holes may be disposed vertically and horizontally in a radiation direction of a wave guide which is penetrated with a plurality of holes.

The first speaker 120 may be disposed to output sound to a front surface of the electronic device 100 which is the projection direction of the projection part 110. For example, the first speaker 120 may be implemented as a directional hole (pattern) array speaker, and disposed to output sound to the front surface of the electronic device 100 which is the projection direction of the projection part 110. For example, the first speaker 120 may include a speaker cover formed with a plurality of holes. Here, the speaker cover may be formed at a front direction at which sound is output from the first speaker 120. The speaker cover may include the plurality of holes which is formed in parallel in the projection direction, and the plurality of holes may have different diameters or areas based on a distance from a point at which sound is output from the first speaker 120. In addition, the speaker cover may be in a form with the remaining portion excluding the plurality of holes sealed. Detailed descriptions with respect to the speaker cover will be described below through the drawings.

However, the embodiment is not limited thereto, and the first speaker 120 may be any speaker so long as it is a directional speaker which can output sound to the front surface of the electronic device 100 that is the projection direction of the projection part 110. For example, the first speaker 120 may be implemented as one from among a Horn Speaker, an End Firing Array Speaker, and a Parametric Array speaker. Alternatively, the first speaker 120 may configure a plurality of speakers as an array, and may be implemented as an array speaker having strong directivity by adjusting time delay and output weight values for each of the speakers.

If a strong directional sound is reflected from the projection surface, an effect of sound sounding from the projection surface may be provided to a user. That is, the screen and the sound image may be matched through an operation of the first speaker 120.

The second speaker 130 may receive an electric signal, and radiate sound by vibrating a diaphragm based on the input electric signal. The second speaker 130 may include sound radiation holes in mesh form which are formed on a sound plane or a certain curved surface to protect the second speaker 130. Alternatively, the sound radiation holes may be implemented in various radiation patterns. However, the embodiment is not limited thereto, and the sound radiation holes may not have a specific form.

The second speaker 130 may be disposed to output sound to at least one from among a back surface or a side surface of the electronic device 100. For example, the second speaker 130 may be implemented as a Mid-Woofer speaker, and may be disposed to output mid to low range sounds to at least one from among the back surface or the side surface of the electronic device 100.

The processor 140 may control an overall operation of the electronic device 100. Specifically, the processor 140 may control the overall operation of the electronic device 100 by being connected with each configuration of the electronic device 100. For example, the processor 140 may control an operation of the electronic device 100 by being connected with configurations such as, for example, and without limitation, the projection part 110, the first speaker 120, the second speaker 130, a sensor (not shown), a user interface (not shown), and the like.

At least one processor 140 may include one or more from among a central processing unit (CPU), a graphics processing unit (GPU), an accelerated processing unit (APU), a many integrated core (MIC), a neural processing unit (NPU), a hardware accelerator, or a machine learning accelerator. The at least one processor 140 may control one or a random combination from among other elements of the electronic device 100, and perform an operation associated with communication or data processing. The at least one processor 140 may execute one or more programs or instructions stored in a memory. For example, the at least one processor 140 may perform, by executing the one or more instructions stored in the memory, a method according to an embodiment of the disclosure.

When a method according to an embodiment of the disclosure includes a plurality of operations, the plurality of operations may be performed by one processor, or performed by the plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The at least one processor 140 may be implemented as a single core processor that includes one core, or as one or more multicore processors that include a plurality of cores (e.g., a homogeneous multicore or a heterogeneous multicore). If the at least one processor 140 is implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the at least one processor 140 may refer to a system on chip (SoC), a single core processor, or multicore processors in which the one or more processors and other electronic components are integrated or a core included in the single core processor or the multicore processor, and the core herein may be implemented as the CPU, the GPU, the APU, the MIC, the NPU, the hardware accelerator, the machine learning accelerator, or the like, but is not limited to the embodiments of the disclosure. However, for convenience of description, an operation of the electronic device 100 will be described below using the expression ‘processor 140.’

The processor 140 may control the first speaker 120 to output a first sound of a first frequency band, and control the second speaker 130 to output a second sound of a second frequency band which is lower than the first frequency band. For example, the processor 140 may control the first speaker 120 to output sound of a high-frequency component that greatly affects a position (localization) of the sound image, and control the second speaker 130 to output sound of a mid to low range component excluding the high-frequency component.

Here, the first sound may be output through the first speaker 120, and constructively interfered by being delayed output sequentially through the plurality of holes formed at the speaker cover of the first speaker 120, and may have directivity in a direction that is being constructively interfered. That is, the first sound may have directivity in the projection direction of the projection part 110, and provide an effect of sound being reflected from the projection surface and heard from the projection surface to the user. Through the operation described above, the screen and the sound image may be matched.

The electronic device 100 may further include a sensor, and the processor 140 may identify a distance from the electronic device 100 to a projection surface through the sensor, and correct at least one delay from among the first sound or the second sound based on the identified distance. For example, the electronic device 100 may include a time of flight (ToF) sensor, and the processor 140 may identify a distance from the electronic device 100 to a projection surface through the ToF sensor, and output the first sound faster or output the second sound slower based on the identified distance. Here, the time being corrected may be time taken until sound reaches the projection surface. Although the first sound is delivered to the user by being reflected from the projection surface after having reached the projection surface, because the second sound is delivered to the user from the electronic device 100, the first sound and the second sound may not be temporally matched, but the problem of not matching temporally may be resolved through the correction of delay as described above.

Meanwhile, the ToF sensor may be a sensor that calculates a distance at which light emitted to an object through infrared waves is reflected back as time with a 3D sensor, and recognizes dimensionality of an object, spatial information, and movement. However, the embodiment is not limited thereto, and the sensor may be a sensor that operates based on distance information obtained from a sensor performing an auto focusing function from the electronic device 100 to the projection surface, and may be any sensor so long as the distance from the electronic device 100 to the projection surface can be identified. In addition, the processor 140 may also identify the distance from the electronic device 100 to the projection surface through a camera.

The electronic device 100 may further include a third speaker which is disposed to output sound to the front surface of the electronic device 100, and includes the speaker cover formed with the plurality of holes, and the processor 140 may control the first speaker 120 to output sound of a first channel from the first sound, and control the third speaker to output sound of a second channel from the first sound. For example, the processor 140 may control the first speaker 120 to output one sound from among a left channel and a right channel from the first sound, and control the third speaker to output the other one sound from among the left channel and the right channel from the first sound. Here, the third speaker may be a speaker which is in a form that is same as the first speaker 120, but that is different in only an installation position.

The electronic device 100 may further include a sensor, and the processor 140 may identify a projection angle formed by the projection direction and the projection surface through the sensor, and correct at least one delay from among the sound of the first channel or the sound of the second channel based on the projection angle. For example, the electronic device 100 may include a first ToF sensor formed adjacently to the first speaker 120 and a second ToF sensor formed adjacently to the third speaker, and the processor 140 may identify a first distance from the first speaker 120 to the projection surface through the first ToF sensor, identify a second distance from the third speaker to the projection surface through the second ToF sensor, and identify a projection angle based on the first distance and the second distance. The processor 140 may correct at least one delay from among the sound of the first channel and the sound of the second channel based on the projection angle. Here, the processor 140 may additionally perform correction according to the above-described distance. If the electronic device 100 is installed at a position spaced apart from a center line of the projection surface, the first distance from the first speaker 120 to the projection surface and the second distance from the third speaker to the projection surface may vary and thereby, the sound output from the first speaker 120 and the sound output from the third speaker may not be temporally matched when reflected by the projection surface and delivered to the user, but the problem of not being a temporal match may be resolved through the correction of delay as described above. However, the embodiment is not limited thereto, and the sensor may be a sensor that operates based on a projection angle (or, a distance with both sides of the screen) obtained from a sensor for performing auto keystone which corrects a distortion of the projection screen of the electronic device 100 when projecting at the side surface, and may be any sensor so long as the projection angle may be obtained.

The electronic device 100 may further include a user interface, and the processor 140 may control, based on a user command for implementing an integrated screen through the electronic device 100 and at least one other electronic device being received through the user interface, the projection part 110 to project a portion of an area of an image, and control the first speaker 120 to output sound of a channel corresponding to a portion of the area from among the first sound. The electronic device 100 may further include a communication interface, and the processor 140 may control the communication interface to transmit a remaining area of the image, a remaining channel of the first sound, and the second sound to the at least one other electronic device.

For example, the processor 140 may control, based on a user command for implementing an integrated screen through the electronic device 100 and other electronic device being received through a user interface, the projection part 110 to project an area half of a left side of an image, and control the first speaker 120 to output sound of the left channel from among the first sound. Then, the processor 140 may control the communication interface to transmit an area half of a right side of the image, the right channel of the first sound, and the second sound to the other electronic device.

The electronic device 100 may further include a user interface, and the processor 140 may control, based on a user command for implementing an integrated screen through the electronic device 100 and at least one other electronic device being received through the user interface, the projection part 110 to project one from among a plurality of content, control the first speaker 120 to output the first sound of the first frequency band from a sound corresponding to one from among the plurality of content, and control the second speaker 130 to output the second sound of the second frequency band from the sound. The electronic device 100 may further include a communication interface, and the processor 140 may control the communication interface to transmit the remaining from among the plurality of content to the at least one other electronic device.

For example, the processor 140 may control, based on a user command for implementing an integrated screen through the electronic device 100, a first other electronic device, and a second other electronic device being received through the user interface, the projection part 110 to project a first content from among the plurality of content, control the first speaker 120 to output the first sound of the first frequency band from the first sound corresponding to the first content, and control the second speaker 130 to output the second sound of the second frequency band from the first sound. The processor 140 may control the communication interface to transmit a second content from among the plurality of content to the first other electronic device, and transmit a third content to the second other electronic device.

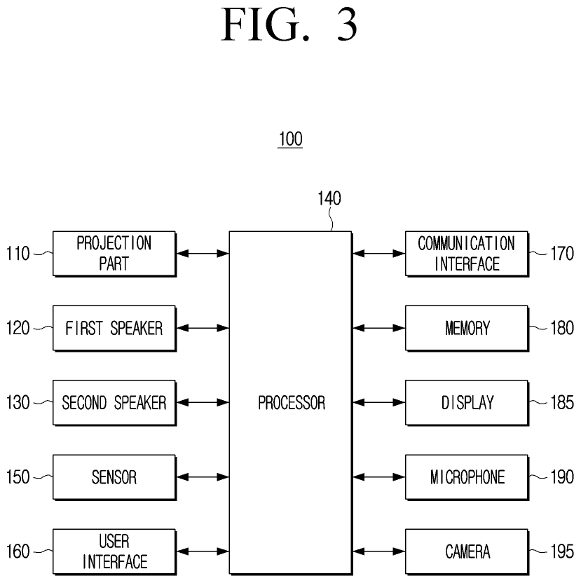

FIG. 3 is a block diagram illustrating a detailed configuration of the electronic device 100 according to an embodiment of the disclosure.

FIG. 3 is a block diagram illustrating a detailed configuration of the electronic device 100 according to an embodiment of the disclosure. The electronic device 100 may include the projection part 110, the first speaker 120, the second speaker 130, and the processor 140. The electronic device 100 may further include a sensor 150, a user interface 160, a communication interface 170, a memory 180, a display 185, a microphone 190, and a camera 195. Detailed descriptions for parts that overlap with the elements shown in FIG. 2 from among the elements shown in FIG. 3 will be omitted.

The sensor 150 may be a sensor for identifying a distance from the electronic device 100 to the projection surface, and may be implemented as the ToF sensor. However, the embodiment is not limited thereto, and the sensor 150 may be any sensor so long as the distance from the electronic device 100 to the projection surface can be identified. In addition, the processor 140 may also identify a distance from the electronic device 100 to a projection surface through the camera 195.

The sensor 150 may include at least one from among an infrared sensor or a tilt sensor, and the processor 140 may identify a projection angle using at least one from among the infrared sensor or the tilt sensor.

The sensor may include sensors of the same type in plurality. For example, the sensor 150 may include the first ToF sensor formed adjacently to the first speaker 120 that outputs the first channel from the first sound and the second ToF sensor formed adjacently to the third speaker that outputs the second channel from the first sound. In this case, the processor 140 may identify the first distance from the first speaker 120 to a projection surface through the first ToF sensor, identify the second distance from the third speaker to a projection surface through the second ToF sensor, and identify the projection angle based on the first distance and the second distance. However, the embodiment is not limited thereto, and the sensor 150 may be any sensor so long as the projection angle can be identified. In addition, the processor 140 may also identify the projection angle through the camera 195.

The user interface 160 may be implemented as a button, a touch pad, a mouse, and a keyboard, or implemented also as a touch screen capable of performing a display function and an operation input function together therewith. Here, the button may be buttons of various types such as a mechanical button, a touch pad, or a wheel which are formed at a random area at a front surface part or a side surface part, a rear surface part, or the like of an exterior of the main body of the electronic device 100.

The communication interface 170 may be a configuration for performing communication with external devices of various types according a communication method of various types. For example, the electronic device 100 may perform communication with a content server or a user terminal device through the communication interface 170.

The communication interface 170 may include a Wi-Fi module, a Bluetooth module, an infrared communication module, a wireless communication module, and the like. Here, each communication module may be implemented in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and various information may be transmitted and received after communicatively connecting using the same. The infrared communication module may perform communication according to an infrared communication (Infrared Data Association (IrDA)) technology of transmitting data wirelessly in short range by using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

Alternatively, the communication interface 170 may include a wired communication interface such as, for example, and without limitation, HDMI, DP, Thunderbolt, USB, RGB, D-SUB, DVI, and the like.

In addition thereto, the communication interface 170 may include at least one from among the wired communication modules that perform communication using a local area network (LAN) module, an Ethernet module, or a pair cable, a coaxial cable or an optical fiber cable, or the like.

The memory 180 may refer to a hardware that stores information such as data in electric or magnetic form for the processor 140 and the like to access. To this end, the memory 180 may be implemented as at least one hardware from among a non-volatile memory, a volatile memory, a flash memory, a hard disk drive (HDD) or a solid state drive (SSD), a random access memory (RAM), a read only memory (ROM), and the like.

In the memory 180, at least one instruction required in an operation of the electronic device 100 or the processor 140 may be stored. Here, the instruction may be a code unit that instructs an operation of the electronic device 100 or the processor 140, and may be prepared in a machine language which is a language that can be understood by a computer. Alternatively, the memory 180 may be stored with a plurality of instructions that perform a specific work of the electronic device 100 or the processor 140 as an instruction set.

The memory 180 may be stored with data which is information in a bit or byte unit that can represent a character, a number, a picture, and the like. For example, the memory 180 may be stored with auto focusing information, auto keystone information, sound control information, and the like.

The memory 180 may be accessed by the processor 140 and reading, writing, modifying, deleting, updating, and the like of the instruction, the instruction set, or data may be performed by the processor 140.

The display 185 may be a configuration that displays an image, and implemented in displays of various forms such as a liquid crystal display (LCD), an organic light emitting diode (OLED) display, and a plasma display panel (PDP). In the display 185, a driving circuit, which may be implemented in a form of an a-si TFT, a low temperature poly silicon (LTPS) TFT, an organic TFT (OTFT), or the like, a backlight unit, and the like may be included. Meanwhile, the display 185 may be implemented as a touch screen coupled with a touch sensor, a flexible display, a three-dimensional display (3D display), or the like.

The microphone 190 may be a configuration for receiving sound and converting to an audio signal. The microphone 190 may be electrically connected with the processor 140, and may receive sound by the control of the processor 140.

For example, the microphone 190 may be formed as an integrated-type integrated to an upper side or a front surface direction, a side surface direction or the like of the electronic device 100. Alternatively, the microphone 190 may be provided in a remote controller, or the like separate from the electronic device 100. In this case, the remote controller may receive sound through the microphone 190, and provide the received sound to the electronic device 100.

The microphone 190 may include various configurations such as a microphone that collects sound in an analog form, an amplifier circuit that amplifies the collected sound, an A/D converter circuit that samples the amplified sound and converts to a digital signal, a filter circuit that removes noise components from the converted digital signal, and the like.

Meanwhile, the microphone 190 may be implemented in a form of a sound sensor, and may be any method so long as it is a configuration that can collect sound.

The camera 195 may be a configuration for capturing a still picture or a moving picture. The camera 195 may capture the still image at a specific time point, but may also capture the still image consecutively.

The camera 195 may capture an image being projected at a projection surface by capturing a front direction of the electronic device 100. The processor 140 may identify at least one from among a distance from the electronic device 100 to the projection surface or a projection angle formed by the projection direction and the projection surface from the image captured through the camera 195.

The camera 195 may include a lens, a shutter, an aperture, a solid-state imaging device, an Analog Front End (AFE), and a Timing Generator (TG). The shutter may be configured to adjust a time during which light reflected from a subject enters the camera 195, and the aperture may be configured to adjust an amount of light incident to the lens by mechanically increasing or decreasing a size of an opening part through which light enters. The solid-state imaging device may be configured to output, based on light reflected from the subject being accumulated as photo charge, an image by the photo charge as an electric signal. The TG may be configured to output a timing signal for reading out pixel data of the solid-state imaging device, and the AFE may be configured to digitalize the electric signal output from the solid-state imaging device by sampling.

The electronic device 100 as described above may provide a user with an experience in which a center of the projection screen and a center of sound are a match. In addition, the electronic device 100 may maintain a left and right balance even when installed at the side surface, and provide the user with an experience in which the projection screen and the sound image are a match. Further, the electronic device 100 may correct a delay between the left and right channels based on the projection angle obtained according to the auto keystone function even if a time align matching of the high-frequency component and the mid to low range component is possible based on the distance from the electronic device 100 to the projection surface, and even if directional speakers are included in the left and right directions. In addition, the electronic device 100 may create a greater screen with the at least one other electronic device, and provide a multi-channel effect by positioning each channel of the sound within the screen.

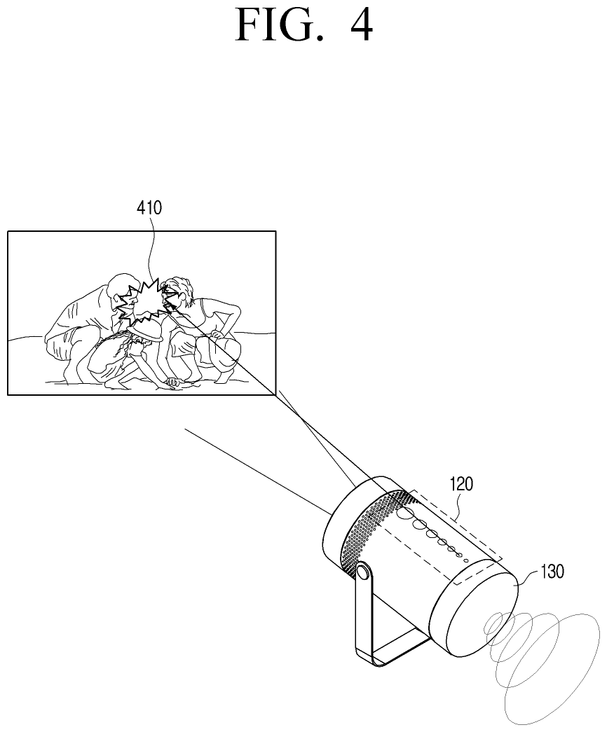

An operation of the electronic device 100 will be described in greater detail below through FIG. 4 to FIG. 12. In FIG. 4 to FIG. 12, individual embodiments will be described for convenience of description, but the individual embodiments of FIG. 4 to FIG. 12 may be implemented in any combined state.

FIG. 4 is a diagram illustrating an operation of the first speaker 120 according to an embodiment of the disclosure.

The processor 140 may control the projection part 110 to project an image to a projection surface at an upper left side as shown in FIG. 4. Here, the electronic device 100 may include the first speaker 120 which outputs sound in the projection direction, and the first speaker 120 may include the speaker cover formed with the plurality of holes. For example, the first speaker 120 may include a tweeter unit which is in charge of high-frequencies with which provision of position information from a recognition aspect is easy and a hole array pattern having a high directivity to deliver a sense (sound image localization) of sound being played back from the screen. The hole array pattern may be implemented in a form in which a plurality of holes penetrated in a direction perpendicular to the projection direction of the electronic device 100 is disposed in a row parallel with the projection direction of the electronic device 100. The hole array pattern may be disposed in a direction that forms a parallel with the projection direction of the electronic device 100.

The sound output from the first speaker 120 may be constructively interfered by being delayed output sequentially through the plurality of holes, and have directivity in a direction that is being constructively interfered. That is, the sound output from the first speaker 120 may have directivity in the projection direction.

The electronic device 100 may include, as shown in FIG. 4, the second speaker 130 disposed to output sound to the back surface of the electronic device 100. However, the embodiment is not limited thereto, and the second speaker 130 may be disposed to output sound to the side surface of the electronic device 100 or output sound to the side surface and back surface of the electronic device 100.

The processor 140 may control the first speaker 120 to output the first sound of the first frequency band, and control the second speaker 130 to output the second sound of the second frequency band which is lower than the first frequency band. For example, the processor 140 may control the first speaker 120 to output sound of a high-frequency component which greatly affects the position of the sound image, and control the second speaker 130 to output sound of a mid to low range component excluding the high-frequency component. That is, the second speaker 130 may reinforce a low range component.

Through the implementation and operation of the first speaker 120 as described above, the screen and a sound image 410 may be matched. In addition, even if the user changes the installation position of the electronic device 100, the sound image may still be maintained on the screen due to the projection direction of the screen and the directivity of the first sound forming a parallel.

In FIG. 4, for convenience of description, the electronic device 100 has been described as including the second speaker 130, but is not limited thereto. For example, the electronic device 100 may be implemented in a form including only the projection part 110, the first speaker 120, and the processor 140. In this case, the processor 140 may control the first speaker 120 to output the whole first sound rather than a portion of the frequency band of the first sound.

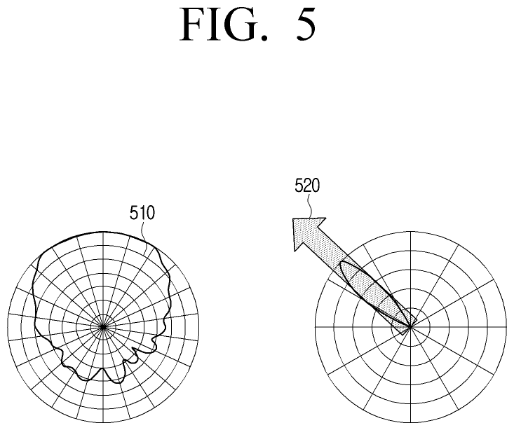

FIG. 5 is a diagram illustrating characteristics of directivity according to an embodiment of the disclosure.

Directivity may have a wide directivity 510 as the left side of FIG. 5, or have a strong directivity 520 as the right side of FIG. 5.

The first speaker 120 may be a speaker having strong directivity, and may employ a method of focusing sound energy to an orientated direction while minimizing sound energy that can be leaked to the side surface. Because the first speaker 120 may provide an effect of sound being heard from walls when projecting at a reflector (a projection surface such as a flat wall and a screen), the above may be used in a multi-channel sound bar (left and right phantom surround), a multi-channel TV (a ceiling channel speaker which allows for the sound image to form at the ceiling), or the like.

FIG. 6 is a diagram illustrating a structure of the first speaker 120 according to an embodiment of the disclosure.

The first speaker 120 may include the speaker cover formed with the plurality of holes. The first speaker 120 may include a speaker unit and the speaker cover. The speaker cover may be implemented, as shown at an upper end of FIG. 6, in a form of a waveguide with holes formed at intervals calculated for controlling the directivity characteristics. The sound output from the speaker unit may be constructively interfered by being delayed output sequentially through the plurality of holes, and may have directivity in a direction that is being constructively interfered.

Specifically, the sound output from the speaker unit may have sound waves radiated in an order starting from a hole near to the speaker unit, and the sound that is delayed output slightly for each hole as shown in FIG. 6 may have the strong directivity in a direction parallel with the projection direction of the electronic device 100.

Although the speaker unit has been described as outputting sound to the right side in the upper end of FIG. 6, the embodiment is not limited thereto. For example, the speaker unit may output sound to an upper side as in a lower end of FIG. 6.

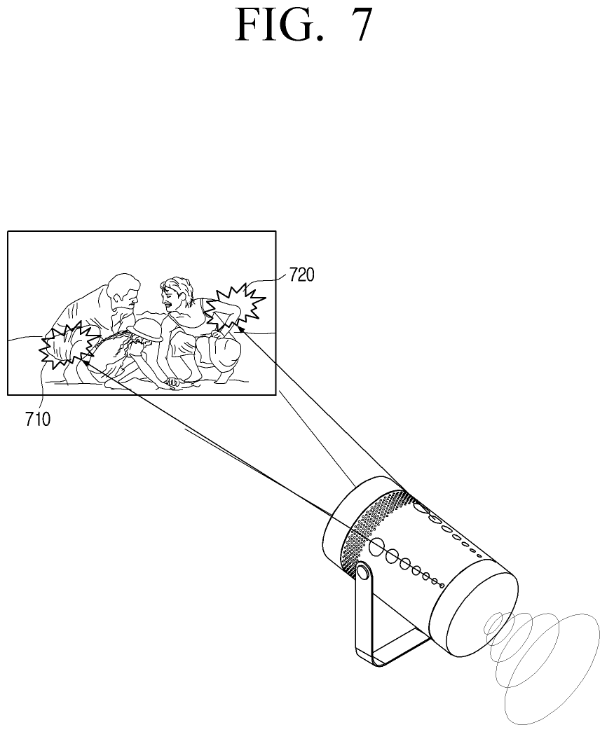

FIG. 7 is a diagram illustrating an example of a multi-channel directional speaker being included according to an embodiment of the disclosure.

The electronic device 100 may include the first speaker 120 which is disposed to output sound to the front surface of the electronic device 100 and includes the speaker cover formed with the plurality of holes, and the third speaker which is disposed to output sound to the front surface of the electronic device 100 and includes the speaker cover formed with the plurality of holes.

The processor 140 may control the first speaker 120 to output sound of the first channel from the first sound, and control the third speaker to output sound of the second channel from the first sound. In this case, the sound of the first channel may be formed with a sound image at a vicinity 710 of the left side of the projection surface, and the sound of the second channel may be formed with a sound image at a vicinity 720 of the right side of the projection surface. Through the operation described above, the user may experience a multi-channel sound effect.

In FIG. 7, although the electronic device 100 has been described as including two directional speakers for convenience of description, the embodiment is not limited thereto. For example, the electronic device 100 may be implemented in a form including three or more directional speakers. In an example, if the electronic device 100 is implemented in a form including four directional speakers, the processor 140 may output sound of a front left channel, sound of a front right channel, sound of a rear left channel, and sound of a rear right channel through each of the four directional speakers. Here, the sound of the front left channel and the sound of the front right channel may be formed with a sound image at the projection surface, and the sound of the rear left channel and the sound of the rear right channel may be formed with a sound image at a floor surface. Alternatively, the sound of the front left channel and the sound of the front right channel may be formed with a sound image at the projection surface, and the sound of the rear left channel and the sound of the rear right channel may be formed with a sound image at a rear direction and provide a surround effect.

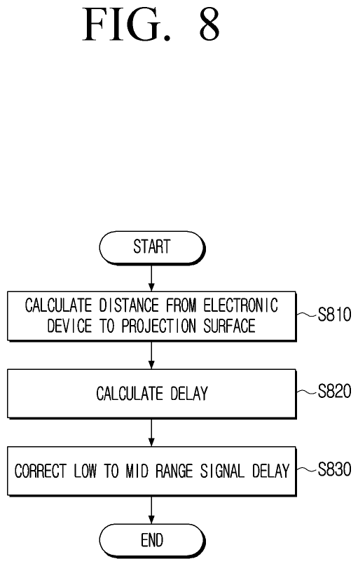

FIG. 8 is a diagram illustrating a time align matching of the first speaker 120 and the second speaker 130 according to an embodiment of the disclosure.

The processor 140 may calculate a distance from the electronic device 100 to a projection surface (S810). For example, the processor 140 may identify the distance from the electronic device 100 to the projection surface based on optical system information of an auto focusing function. In an example, the processor 140 may identify the distance between the electronic device 100 and the projection surface when the optical system is in focus after proceeding with auto focusing. Here, the auto focusing function may refer to a function that automatically performs focusing according to the distance of the projection surface varying.

The processor 140 may calculate a delay (S820). A delivery time of the first speaker 120 may be a propagation delay which needs to be delivered back to the ears of the user after having reached the projection surface, and may be about two times of the distance from the electronic device 100 to the projection surface. For example, the delay may be calculated as below.

$$delay ( sec ) = distance ( m ) \times 2 / 345 ( m / s )$$

Here, 345 (m/s) may be a speed of sound.

The processor 140 may correct the sound delay of the mid to low range component (S830). For example, the second speaker 130 may be delayed in output by a delay time than the first speaker 120. Here, because the delay time is very short, a picture and sound may be slightly out of synchronization (or sync), but it would be difficult for the user to recognize the above.

Alternatively, in order to minimize the picture and sound being out of sync, the processor 140 may change both output of the first speaker 120 and the second speaker 130. For example, the processor 140 may output the sound of the first speaker 120 faster by delay/2, and output the sound of the second speaker 130 slower by delay/2. In this case, the sync of picture and sound may be reduced by delay/2 making it more difficult for the user to recognize being out of sync.

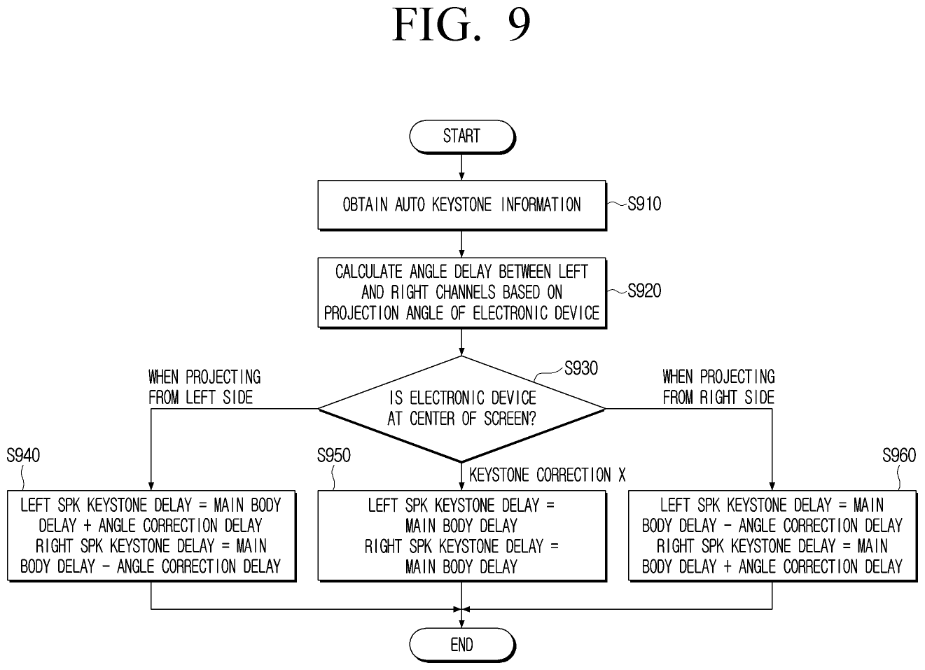

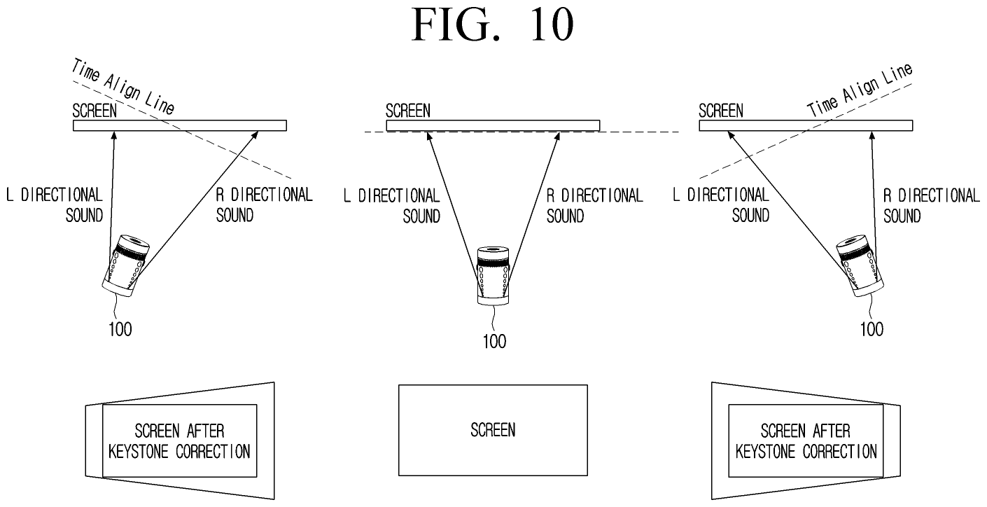

FIG. 9 and FIG. 10 are diagrams illustrating a time align matching when a multi-channel directional speaker is included according to an embodiment of the disclosure.

If a center of a lens of the projection part 110 and a center of a projection surface are not a match, the projection area by the projection part 110 may be distorted to a trapezoidal shape. The processor 140 may correct the projection area in trapezoidal shape to a rectangular form through the auto keystone function. The processor 140 may obtain a projection angle in a process of using the auto keystone function, and correct a delay in the multi-channel directional speaker based on the projection angle. In FIG. 9 and FIG. 10, it may be assumed that two directional speakers including a left speaker and a right speaker are included for convenience of description.

First, the processor 140 may obtain auto keystone information (S910), and calculate an angle delay between the left and right channels based on the projection angle of the electronic device 100 (S920).

The processor 140 may identify whether the electronic device 100 is at a center of the screen (S930). The processor 140 may obtain, based on the electronic device 100 projecting from the left side as in a left side of FIG. 10, a value summing a main body delay and an angle correction delay as a keystone delay of the left speaker, and obtain a value subtracting the angle correction delay from the main body delay as the keystone delay of the right speaker (S940).

The processor may obtain, based on the electronic device 100 being disposed at the center of the screen as in a center of FIG. 10, the main body delay as the keystone delay of the left speaker and the keystone delay of the right speaker (S950).

The processor 140 may obtain, based on the electronic device 100 projecting from the right side as in a right side of FIG. 10, the value subtracting the angle correction delay from the main body delay as the keystone delay of the left speaker, and obtain the value summing the main body delay and the angle correction delay as the keystone delay of the right speaker (S960).

The processor 140 may correct a slight distortion of the left and right channels through the operation described above.

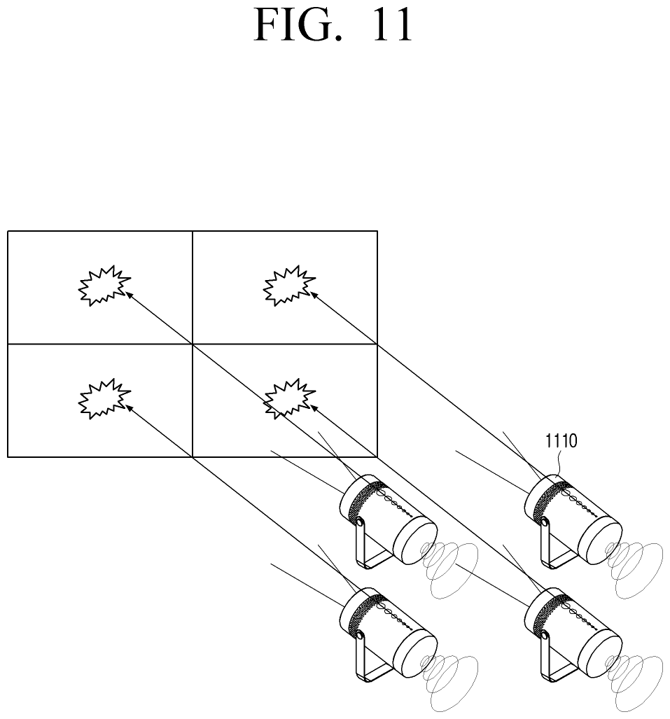

FIG. 11 is a diagram illustrating an operation of the electronic device 100 when projecting one image using the electronic device 100 and at least one other electronic device according to an embodiment of the disclosure.

The processor 140 may control, based on a user command for implementing an integrated screen through the electronic device 100 and at least one other electronic device being received through the user interface 160, the projection part 110 to project a portion of an area of an image, and control the first speaker 120 to output sound of a channel corresponding to the portion of the area from among the first sound.

The processor 140 may control the communication interface 170 to transmit a remaining area of the image, a remaining channel of the first sound, and the second sound to the at least one other electronic device.

For example, if a device positioned at 1110 in FIG. 11 is assumed as the electronic device 100, the processor 140 may control, based on the user command for implementing the integrated screen through the electronic device 100 and at least one other electronic device being received through the user interface 160, the projection part 110 to project a right upper area of the image, and control the first speaker 120 to output sound of a channel corresponding to the right upper area from among the first sound which includes the high-frequency component corresponding to the image.

The processor 140 may control the communication interface 170 to transmit a remaining area excluding the right upper area of the image, a remaining channel of the first sound, and the second sound to the at least one other electronic device.

The processor 140 through the operation described above may have a plurality of sound images formed at a plurality of projection areas, respectively. Accordingly, the processor 140 may provide consumers with not only stereo, but also multi-channel sounds such as surround and ATMOS.

In FIG. 11, although four devices have been shown for convenience of description, the embodiment is not limited thereto, and one image may be projected by any number of devices.

In addition, in FIG. 11, the electronic device 100 has been described as providing an image and sound to at least one other electronic device, but the embodiment is not limited thereto. For example, a user terminal device may provide an image and sound corresponding to each of the areas to each of the four devices in FIG. 11.

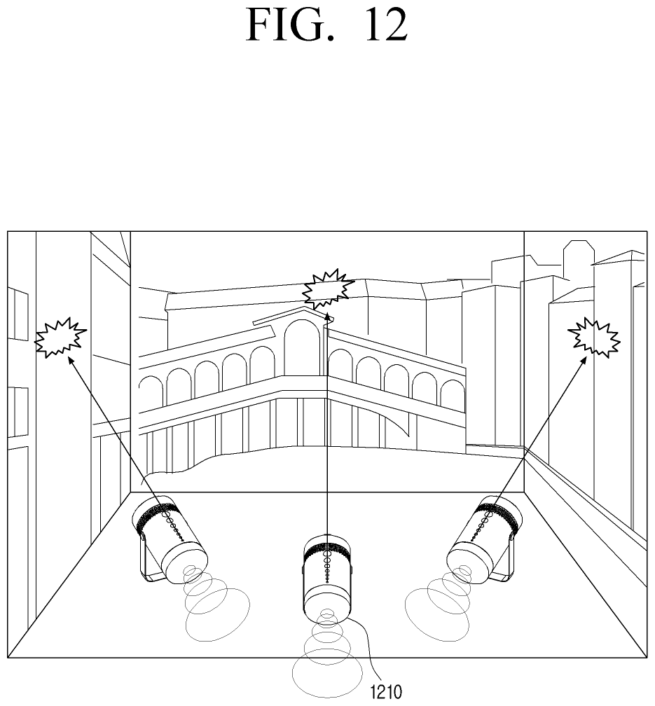

FIG. 12 is a diagram illustrating an operation of the electronic device 100 when projecting a plurality of content using the electronic device 100 and at least one other electronic device according to an embodiment of the disclosure.

The processor 140 may control, based on the user command for implementing the integrated screen through the electronic device 100 and at least one other electronic device being received through the user interface 160, the projection part 110 to project one from among the plurality of content, control the first speaker 120 to output the first sound of the first frequency band from a sound corresponding to one from among the plurality of content, and control the second speaker 130 to output the second sound of the second frequency band from the sound.

The processor 140 may control the communication interface 170 to transmit the remaining from among the plurality of content to the at least one other electronic device.

For example, assuming that a device positioned at 1210 in FIG. 12 is the electronic device 100, the processor 140 may control, based on the user command for implementing the integrated screen through the electronic device 100 and at least one other electronic device being received through the user interface 160, the projection part 110 to project the first content from among the plurality of content at a front area, control the first speaker 120 to output the first sound of the first frequency band from a sound corresponding to the first content, and control the second speaker 130 to output the second sound of the second frequency band from the sound.

The processor 140 may control the communication interface 170 to transmit the second content and the third content from among the plurality of content to the other electronic device at the left side and the other electronic device at the right side, respectively. In this case, the other electronic device at the left side may project the second content to a left area, control the directional speaker to output sound of the first frequency band from a sound corresponding to the second content, and control the speaker outputting mid to low range sounds to output sound of the second frequency band from a sound corresponding to the second content. The other electronic device at the right side may project the third content to a right area, control the directional speaker to output sound of the first frequency band from a sound corresponding to the third content, and control the speaker outputting the mid to low range sounds to output sound of the second frequency band from a sound corresponding to the third content.

Through the operation described above, sound images may be formed at each of the left area, the front area, and the right area, and a sense of consistency of the left area, the front area, and the right area may be improved.

In FIG. 12, although three devices have been shown for convenience of description, the embodiment is not limited thereto, and the plurality of content may be projected by any number of devices.

In addition, in FIG. 12, the electronic device 100 has been described as providing the remaining from among a plurality of content to at least one other electronic device, but the embodiment is not limited thereto. For example, the user terminal device may provide the plurality of content to each of the three devices in FIG. 12.

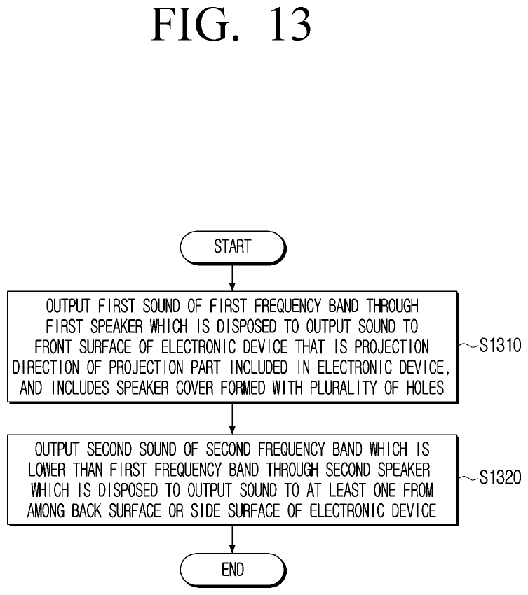

FIG. 13 is a flowchart illustrating a control method of an electronic device according to an embodiment of the disclosure.

First, the first sound of the first frequency band may be output through the first speaker which is disposed to output sound to the front surface of the electronic device which is the projection direction of the projection part included in the electronic device and includes the speaker cover formed with the plurality of holes (S1310). Then, the second sound of the second frequency band which is lower than the first frequency band may be output through the second speaker which is disposed to output sound to at least one from among the back surface of the side surface of the electronic device (S1320).

Here, the speaker cover may include the plurality of holes formed in parallel in the projection direction, and the plurality of holes may have varying diameters and areas based on the distance with the output point of the first sound.

Further, the speaker cover may be in the form with the remaining portion excluding the plurality of holes sealed, and the first sound may be output from the first speaker, and constructively interfered by being delayed output sequentially through the plurality of holes, and may have directivity in a direction that is being constructively interfered.

Meanwhile, identifying a distance from the electronic device to a projection surface and correcting at least one delay from among the first sound and the second sound based on the identified distance may be further included.

In addition, the outputting the first sound (S1310) may include outputting the sound of the first channel from the first sound through the first speaker, and outputting the sound of the second channel from the first sound through the third speaker which is disposed to output sound to the front surface of the electronic device and includes the speaker cover formed with the plurality of holes.

Here, identifying the projection angle formed by the projection direction and the projection surface and correcting at least one delay from among the sound of the first channel and the sound of the second channel based on the projection angle may be further included.

Meanwhile, receiving the user command for implementing the integrated screen through the electronic device and at least one other electronic device and controlling the projection part to project the portion of the area of the image may be further included, and outputting the first sound (S1310) may include outputting the sound of the channel corresponding to the portion of the area from among the first sound.

Here, transmitting a remaining area of the image, the remaining channel of the first sound, and the second sound to the at least one other electronic device may be included.

Meanwhile, receiving the user command for implementing the integrated screen through the electronic device and at least one other electronic device and controlling the projection part to project one from among the plurality of content may be further included, and the outputting the first sound (S1310) may include outputting the first sound of the first frequency band from a sound corresponding to one from among the plurality of content, and outputting the second sound (S1320) may include outputting the second sound of the second frequency band from the sound.

Here, transmitting the remaining from among the plurality of content to the at least one other electronic device may be further included.

Meanwhile, the projection part may require a focal distance of greater than or equal to a pre-set distance.

According to various embodiments of the disclosure as described above, the electronic device may provide the user with an experience in which the center of the projection screen and the center of sound are a match.

In addition, the electronic device may maintain the left and right balance even if installed at the side surface, and provide the user with an experience in which the projection screen and the sound image are a match.

Further, the electronic device may perform the time align matching of the high-frequency component and the mid to low range component based on the distance from the electronic device to the projection surface, and correct the delay between the left and right channels based on the projection angle obtained according to the auto keystone function even when the directional speakers are provided left and right.

In addition, the electronic device may may create the greater screen with the at least one other electronic device, and provide the multi-channel effect by positioning each channel of the sound within the screen.

Meanwhile, according to an embodiment of the disclosure, the various embodiments described above may be implemented with software including instructions stored in a machine-readable storage media (e.g., computer). The machine may call a stored instruction from a storage medium, and as a device operable according to the called instruction, may include the electronic device (e.g., electronic device (A)) according to the above-mentioned embodiments. Based on a command being executed by the processor, the processor may directly or using other elements under the control of the processor perform a function corresponding to the command. The command may include a code generated by a compiler or executed by an interpreter. The machine-readable storage media may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, according to an embodiment of the disclosure, the various embodiments described above may be implemented in a recordable medium which is readable by a computer or a device similar to the computer using software, hardware, or the combination thereof. In some cases, embodiments described herein may be implemented by the processor itself. According to a software implementation, embodiments such as the procedures and functions described herein may be implemented as separate software. Each software may perform one or more functions and operations described herein.

Meanwhile, computer instructions for performing processing operations in the device according to the various embodiments described above may be stored in a non-transitory computer-readable medium. The computer instructions stored in this non-transitory computer-readable medium may cause a specific device to perform a processing operation in the device according to the above-described various embodiments when executed by a processor of the specific device. The non-transitory computer-readable medium may refer to a medium that stores data semi-permanently rather than storing data for a very short time, such as a register, a cache, a memory, or the like, and is readable by the device. Specific examples of the non-transitory computer-readable medium may include, for example, and without limitation, a compact disc (CD), a digital versatile disc (DVD), a hard disc, a Blu-ray disc, a USB, a memory card, a ROM, and the like.

In addition, respective elements (e.g., a module or a program) according to the various embodiments described above may be formed of a single entity or a plurality of entities, and a portion of sub-elements from among the above-mentioned sub-elements may be omitted or other sub-elements may be further included in the various embodiments. Alternatively or additionally, a portion of the elements (e.g., modules or programs) may be integrated into one entity to perform the same or similar functions performed by the respective relevant elements prior to integration. Operations performed by a module, a program, or other element, in accordance with the various embodiments, may be executed sequentially, in parallel, repetitively, or in a heuristically manner, or at least a portion of the operations may be executed in a different order, omitted, or a different operation may be added.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

1. An electronic device, comprising:
a projection part;
a first speaker to output sound toward a front surface of the electronic device that is a projection direction of the projection part, the first speaker including a speaker cover formed with a plurality of holes;
a second speaker to output sound toward at least one of a back surface or a side surface of the electronic device; and
at least one processor configured to control the electronic device by being connected with the projection part, the first speaker, and the second speaker,
wherein the at least one processor is configured to:
control the first speaker to output a first sound of a first frequency band, and
control the second speaker to output a second sound of a second frequency band which is lower than the first frequency band.

2. The electronic device of claim 1, wherein
the plurality of holes of the speaker cover are parallel to the projection direction, and
the plurality of holes have different diameters or areas based on a distance from an output point of the first sound.

3. The electronic device of claim 1, wherein
the speaker cover has a remaining portion excluding the plurality of holes that is sealed, and
the first sound is output from the first speaker such that the first sound is constructively interfered by being delayed sequentially and output through the plurality of holes, and has directionality in a direction that is being constructively interfered.

4. The electronic device of claim 1, further comprising:
a sensor,
wherein the at least one processor is configured to:
identify a distance from the electronic device to a projection surface through the sensor, and
correct at least one delay from among the first sound or the second sound based on the identified distance.

5. The electronic device of claim 1, further comprising:
a third speaker to output sound toward the front surface of the electronic device, the third speaker includes a speaker cover formed with a plurality of holes;
wherein the at least one processor is configured to:
control the first speaker to output sound of a first channel from the first sound, and
control the third speaker to output sound of a second channel from the first sound.

6. The electronic device of claim 5, further comprising:
a sensor,
wherein the at least one processor is configured to:
identify a projection angle formed by the projection direction and a projection surface through the sensor, and
correct at least one delay from among the sound of the first channel or the sound of the second channel based on the projection angle.

7. The electronic device of claim 1, further comprising:
a user interface,
wherein the at least one processor is configured to:
control, based on a user command for implementing an integrated screen through the electronic device and at least one other electronic device being received through the user interface, the projection part to project a portion of an area of an image, and
control the first speaker to output sound of a channel corresponding to the portion of the area from among the first sound.

8. The electronic device of claim 7, further comprising:
a communication interface,
wherein the at least one processor is configured to:
control the communication interface to transmit a remaining area of the image, a remaining channel of the first sound, and the second sound to the at least one other electronic device.

9. The electronic device of claim 1, further comprising:
a user interface,
wherein the at least one processor is configured to
control, based on a user command for implementing an integrated screen through the electronic device and at least one other electronic device being received through the user interface, the projection part to project one from among a plurality of content,
control the first speaker to output the first sound of the first frequency band from a sound corresponding to one from among the plurality of content, and
control the second speaker to output the second sound of the second frequency band from the sound.

10. The electronic device of claim 9, further comprising:
a communication interface,
wherein the at least one processor is configured to:
control the communication interface to transmit a remaining content of the plurality of content to the at least one other electronic device.

11. The electronic device of claim 1, wherein
the projection part requires a focal distance of greater than or equal to a pre-set distance.

12. A control method of an electronic device, the control method comprising:
outputting a first sound of a first frequency band through a first speaker toward a front surface of the electronic device that is a projection direction of a projection part included in the electronic device, the first speaker including a speaker cover formed with a plurality of holes; and
outputting a second sound of a second frequency band, which is lower than the first frequency band through a second speaker, toward at least one of a back surface or a side surface of the electronic device.

13. The control method of claim 12, wherein
the plurality of holes of the speaker cover are parallel to the projection direction, and
the plurality of holes have different diameters or areas based on a distance from an output point of the first sound.

14. The control method of claim 12, wherein
the speaker cover includes a remaining portion excluding the plurality of holes that is sealed, and
the first sound is output from the first speaker, constructively interfered by being delayed output sequentially through the plurality of holes, and has directionality in a direction that is being constructively interfered.

15. The control method of claim 12, further comprising:
identifying a distance from the electronic device to a projection surface; and
correcting at least one delay from among the first sound or the second sound based on the identified distance.
